(19) United States
(12) Patent Application Publication
(10) Pub. No.: US 2007/0214922 A1
(43) Pub. Date: Sep. 20, 2007

(54) BAND SAW BLADE

(76) Inventors: James Timothy Cook, Newton, AL (US); Stephen Othniel Cook, Newton, AL (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/678,935

(22) Filed: Feb. 26, 2007

Related U.S. Application Data
(63) Continuation-in-part of application No. 11/399,197, filed on Apr. 6, 2006.
(60) Provisional application No. 60/836,190, filed on Aug. 8, 2006.
(60) Provisional application No. 60/845,672, filed on Sep. 19, 2006.
(60) Provisional application No. 60/776,634, filed on Feb. 25, 2006.
(60) Provisional application No. 60/885,835, filed on Jan. 19, 2007.

(51) Int. Cl. B23D 61/12; B23D 63/00

(52) U.S. Cl. 83/13; 76/112; 83/835

(57) ABSTRACT

The present disclosure relates to band saw blades often used for cutting wood at a sawmill. A band saw blade has teeth, and at least one tooth has a back angle that is greater than the back angle of conventional band saw blades. The greater back angle results in teeth having a smaller tooth angle so that the teeth make deeper penetration into wood or other materials that are cut by the blade.

### CROSS-REFERENCE TO RELATED APPLICATIONS

This application is a continuation-in-part of and claims priority to U.S. Utility patent application Ser. No. 11/399,197 entitled “Band Saw Blade” filed on Apr. 6, 2006. This application also claims priority to U.S. Provisional Patent Application No. 60/776,634, entitled “Band Saw Blade” filed on Feb. 25, 2006; U.S. Provisional Patent Application No. 60/836,190, entitled “Grind Rock for Making Band Saw Blade” filed on Aug. 8, 2006; U.S. Provisional Patent Application No. 60/845,672, entitled “Method and Apparatus for Manufacturing Band Saw Blade with Novel Profile” filed on Sep. 19, 2006; and U.S. Provisional Patent Application No. 60/885,835 entitled “Band Saw Blade” filed on Jan. 19, 2007. All of the foregoing provisional and non-provisional applications are incorporated by reference herein.

### FIELD OF THE DISCLOSURE

The present disclosure generally relates to the field of band saw blades for cutting wood and other relatively soft materials, such as plastics or meats for example.

### RELATED ART

The teeth of a band saw blade work as tiny planing tools that generate chips at a high speed by planing and/or tearing, the chips being collected and removed in the tooth gullets. It is a typical feature of band saw blades that the teeth are set, swaged or otherwise configured so as to provide a kerf (a space generated by the cutting) that is somewhat greater than the blade thickness, for example, twice the blade thickness. The kerf provides a widened path for passing the body of the blade through the material being cut. In addition, the kerf serves as a channel for removal of material waste, such as, for example, sawdust and wood chips in an industrial wood cutting operation such as a sawmill. In such wood cutting operations, the blade may have a thickness of approximately twenty five thousandths of an inch and the kerf thickness may be about fifty-five thousandths of an inch.

Current blade developments and improvements are generally related to new materials and improved manufacturing techniques. There are accepted requirements or standards for parameters of a band saw blade as will be seen. Such standards generally guarantee that blades have strong teeth and operate for a designated amount of time without requiring maintenance.

Generally, a band saw blade is replaced because of tooth wear, stress or some other performance-limiting problem. A worn blade, such as a blade with worn teeth, causes an undesirable loss in efficiency that may cause the blade to break due to increased stress. In addition, a worn blade may cause damage to the body of the band saw. A worn blade also increases power requirements thereby increasing the energy expense of the sawing operation. In general, a first saw blade is said to be more efficient than a second saw blade when the first blade requires less energy for performing a desired cutting action. Hence, it is desirable to minimize tooth wear in order to have a more efficient sawing operation.

Further, a wood sawing operation generally becomes more productive and profitable when the amount of time between blade changes increases. For example, in a continuous sawing operation, changing a blade every 8 hours usually causes twice the band saw downtime as changing a blade every 16 hours. In general, a sawmill using a band saw or other cutting apparatus regards downtime as undesirable since there is usually a cost associated with non-productive use of the saw. Consequently, it is desirable to have an improved blade that minimizes downtime.

Blade material and blade processing, such as improved heat treatment, have resulted in desirable improvements in blade efficiency. By selecting an improved blade stock material and using advanced treatment techniques, blades have been significantly improved.

Blade shaping, i.e. modifying the geometric shapes associated with the blade, is also used for improving blade efficiency. Blade shapes are described in manufacture's literature and in patents such as those referenced below. Such shape modifications, for example, include varying tooth spacing, sharpening multiple blade surfaces and alternating tooth set patterns.

Related publications that provide additional background material are included to provide an understanding of blade structure, prior art blade attributes and other blade characteristics. The disclosures of each patent are hereby incorporated herein by reference in their entirety:

U.S. Pat. No. 6,598,509, Jul. 29, 2003, Cutting Tool Tooth Form Including Set Teeth with Surface Features and Method of Making Same; U.S. Pat. No. 6,681,674, Jan. 27, 2004, Band Saw Blade; U.S. Pat. No. 6,276,248, Aug. 21, 2001, Band Saw Blade Having Reduced Noise and Uniform Tooth Loading Characteristics; U.S. Pat. No. 4,011,783, Mar. 15, 1977, Circular Saw; U.S. Pat. No. 4,423,553 Jan. 3, 1984, Blade for a Saw and a Method for Manufacturing the Same; U.S. Pat. No. 4,557,172 Dec. 10, 1985, Saw Blade; U.S. Pat. No. 4,727,788 Mar. 1, 1988, Saw Blade; U.S. Pat. No. 4,813,324 May 9, 1989, Saw Blade; U.S. Pat. No. 4,827,822 May 9, 1989, Saw Blade; U.S. Pat. No. 5,331,876 Jul. 26, 1994, Saw Blade for Cutting Metal; U.S. Pat. No. 5,425,296 Jun. 20, 1995, Saw Blade; U.S. Pat. No. 5,477,763 Dec. 26, 1995, Saw Blade; U.S. Pat. No. 5,603,252, Feb. 18, 1997, Saw Blade; WO/98/07545 Feb. 26, 1998, Tooth Structure of Band Saw Blade.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 illustrates a side view of a conventional band saw blade.

FIG. 2A illustrates a top view of the band saw blade of FIG. 1 with swaged teeth.

FIG. 2B illustrates a top view of a band saw blade having set teeth.

FIG. 2C illustrates a cross section of the band saw blade of FIG. 2A.

FIG. 2D illustrates a cross section of the band saw blade of FIG. 2B.

FIG. 3 illustrates an embodiment of a band saw blade of the present disclosure.

FIG. 4 illustrates another embodiment of a band saw blade of the present disclosure.

FIG. 5 depicts an embodiment of a grind rock for making the blade of FIG. 3.

FIG. 6 depicts the grind rock of FIG. 5 when positioned for removing blade material.

FIG. 7A depicts the grind rock of FIG. 5 engaged in the cutting process for making the blade of FIG. 3.

FIG. 7B is a cross section view of FIG. 7A.

FIG. 8 illustrates a position of a grind rock at an intermediate stage of a cutting process.

FIG. 9 illustrates a position of a grind rock near the end of a cutting process.

FIG. 10 illustrates an exemplary method for making a blade, such as is depicted in FIG. 3.

### DETAILED DESCRIPTION

The present disclosure generally pertains to band saw blades. Exemplary embodiments of the disclosure described herein pertain to band saw blades used in sawmills for cutting a work piece, such as a log, into lumber. In order to provide a better understanding of band saw blade structures, a general description of conventional blade geometry is provided below.

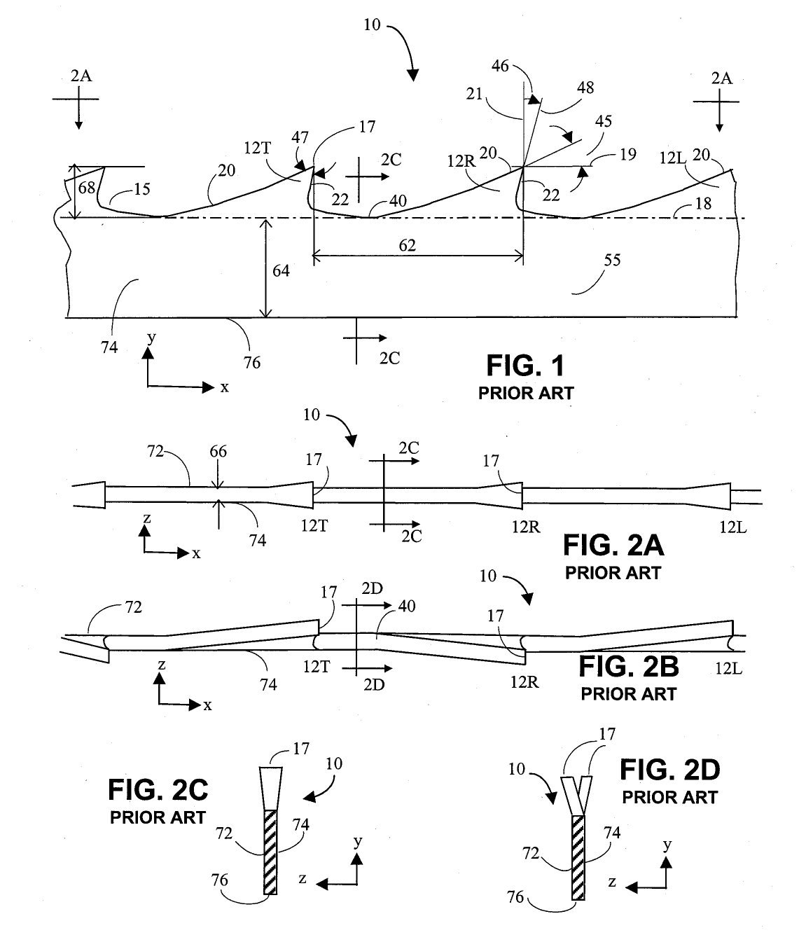

Referring to FIG. 1 there is shown a conventional blade 10 having teeth 12 for cutting and removing material from a work piece (not shown), such as, for example a log or other piece of wood. In order to cut the work piece, blade 10 moves in the x direction at a desired blade velocity. In some wood cutting processes, the work piece moves in the negative y direction at a desired feed velocity and engages blade 10. In other wood cutting processes, the work piece remains stationary and blade 10 moves at a desired feed velocity in the y direction. The blade velocity and the feed velocity are generally selectable parameters and have values dependent upon a variety of factors such as, for example, available drive power, blade cutting characteristics, and the characteristics of the work piece.

A reference tooth 12R is adjacent to a leading tooth 12L, located in the x direction from the reference tooth 12R. The leading tooth 12L makes contact with the work piece and removes some material from the work piece before reference tooth 12R makes contact with and removes additional material from the work piece. A trailing tooth 12T, also adjacent to the reference tooth 12R, is located in the negative x direction from the reference tooth 12R. The trailing tooth 12T also removes material and makes contact with the work piece some time after the reference tooth 12R has made contact. The band saw blade 10 is coupled end-to-end (typically welded) thereby forming a loop that is sometimes referred to an endless loop. The band saw blade 10 is placed over a motor-driven band wheel (not shown) that rotates and provides blade velocity. Further, roller guides direct the band saw blade along a desired path. In general, each tooth 12 removes material from the work piece during a complete blade rotation. The number of teeth 12 in a blade 10 depends on the circumference of blade loop and the distance 62 between the teeth 12. Typically, the distance 62 between teeth 12 of a wood cutting blade is between approximately one half inch and an inch, although other distances are also used. The circumference of a blade may be several feet or more.

Each tooth 12 of the blade 10 in FIG. 1 has a tooth tip 17 (e.g., a point or other type of edge) that penetrates and moves through the work piece. The tip 17 of a tooth may form a sharp point and is often referred to as the “tooth point.”

Moreover, the tip 17 can have various shapes, but it generally forms a sharp edge that can help the tooth penetrate the material being cut. Blade 10 cuts the work piece as each tooth 12 moves through the work piece and removes material. Extending in the negative x direction and slightly downward (the negative y direction) from tooth tip 17 is a backside or back surface 20 of tooth 12. Below (the y direction) the tooth tip 17 is a front side or front surface 22 of tooth 12 that is often referred to as the face of tooth 12. The lower part of front surface 22 is generally referred to as a gullet 15 of tooth 12. The area of the blade 10 above, in the y direction, a reference line 18 is referred to as the tooth area of blade 10. The area of blade 10 below, the negative y direction, reference line 18 is a body 55 of blade 10. The body 55 of conventional blade 10 has a height 64 and each tooth of conventional blade 10 has a tooth height 68. The distance between the teeth, measured in the x direction is referred to as tooth spacing 62.

Back surface 20 intersects blade face 22 of the tooth 12 to form tooth tip 17. Each tooth 12 has a back angle 45. The term “back angle” is known in the art and refers to the angle between back surface 20 at the tooth tip 17 and a horizontal line 19 (i.e., parallel to the x direction, which is orthogonal to the direction of motion of the work piece) as shown in FIG. 1. Back angle 45 of conventional band saw blade 10 is typically about 30-31 degrees (a de facto standard). It is generally accepted by blade manufactures that back angle 45 should be about 30-31 degrees or less in order to keep the risk of tooth fracture within an acceptable margin.

In addition to having a back angle 45, each tooth 12 has a hook angle 46 (also referred to as a face angle). The term “hook angle” is known in the art and refers to the angle measured between a vertical line 21 (i.e., parallel to the y direction, which is orthogonal to the x direction) and a line 48 parallel to the face surface 22 as measured from tooth tip 17, as shown in FIG. 1. Hook angle 46 is a positive angle when measured in a clockwise direction from vertical line 21. A conventionally accepted value for hook angle 46 is around 10 degrees. However, some hook angles 46 have values in the range from approximately minus 5 degrees to plus 12 degrees.

Each tooth 12 of conventional blade 10 also has a tooth angle 47. Tooth angle 47 is defined as the angle between back surface 20 and face surface 22 of the tooth 12 as measured from tooth tip 17 as seen in FIG. 1. The tooth angle 47 for conventional blade 10 typically has a value of around 49 degrees or more. For such a typical tooth angle 47, back angle 45 is usually about 30-31 degrees or less, and hook angle 46 is around 10 degrees. Gullet 15 of face surface 22 generally has a concave shape, although other shapes are possible.

Band saw blade 10 has a left side with a left side surface 74 and a right side with a right side surface 72. The distance between the left side surface 74 and the right side surface 72 is the thickness 66 (best seen in FIG. 2A) of blade 10. Band saw blade 10 typically has a thickness 66 between approximately 35 thousandths of an inch and 55 thousandths of an inch, although other thickness are possible. In general, blade 10 is made of steel, such as, for example, 1074 or 1075 carbon steel. Other materials may be used for blade 10.

When looking downward, the negative y direction, the top of tooth edges can be seen in FIG. 2A. Although the sides of each tooth 12 are generally parallel to the sides of the body 55, the teeth as shown in FIG. 2A are swaged, i.e. the teeth are thicker at and adjacent to tooth tip 17 than at the base of each tooth 12. Swaged tooth 12 produces a kerf (an opening that is wider than blade thickness 66) as the blade moves through the work piece. FIG. 2B illustrates a blade having teeth that are set, i.e. alternately bent outward, for removing material to form the kerf. FIG. 2C depicts a cross section of a blade having swaged teeth 12. A blade having set teeth 12 is shown in FIG. 2D. Setting teeth or swaging teeth are generally accepted as techniques for providing the kerf as band saw 10 cuts the work piece. The kerf serves as a channel for disposing of material, such as wood chips or sawdust that is removed by each tooth 12 of band saw blade 10. Gullet 15 of conventional blade 10 functions as a scoop for pulling wood chips away from the work piece and through the kerf.

The inventors have realized that the back angle for teeth of a band saw blade that is to be used for wood cutting operations and other relatively soft material can be significantly increased without a significant increase in incidence of tooth fracture. Thus, significant increases in the back angle for teeth of band saw can dramatically improve results of a sawing operation without incurring a significant penalty in terms of tooth fracture.

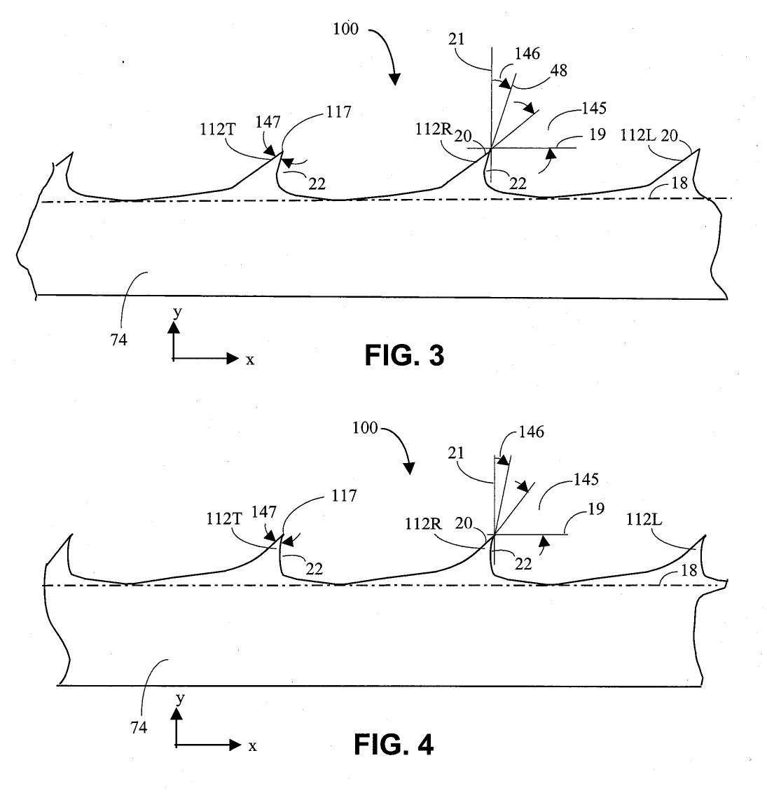

An embodiment of a band saw blade 100 of the present disclosure is illustrated in FIG. 3. In general, blade 100 can be composed of any material used or that may be used for conventional blade 10. Further, various blade parameters, such as, for example, blade thickness 66, tooth height 68 and tooth spacing 62 may be the same or approximately the same for blade 100 as for conventional blade 10. In one exemplary embodiment, the blade 100 is composed of steel (e.g., 1074 or 1075 carbon steel) and has a thickness of about 35 thousandths of an inch to about 55 thousandths of an inch. Further, the tooth height 68 (in the y direction) for each tooth is about ⅜ to ½ of an inch, and the tooth spacing 62 is about ½ to 1 inch. In other embodiments, other material and/or dimensions may be employed.

Contrary to conventional teachings, back angle 145, as shown in FIG. 3, is significantly greater than back angle 45, typically about 30-31 degrees or less, of conventional blade 10. In one exemplary embodiment, the back angle 145 is about 46 degrees, although other angles greater than 31 degrees are possible. Hook angle 146 for an embodiment of band saw blade 100 is approximately 10 degrees, although other values for the hook angle 146 are possible. Indeed, experiments have shown that having a back angle 145 of about 46 degrees and a hook angle of about 6 degrees yields very good results.

The 46 degree back angle 145 of the disclosed embodiment 100 is 15 degrees steeper than the 31 degree back angle 45 of the conventional band saw blade 10. Because back angle 145 for blade 100 is steeper (numerically greater) than back angle 45 of conventional blade 10, the tooth angle 147 of band saw blade 100 is smaller than the tooth angle 47 of blade 10. Because tooth angle 147 of the disclosed embodiment of improved blade 100 is smaller, the tooth 112 of band saw blade 100 penetrates material, such as wood, to a greater depth. Such greater penetration of tooth 112 results in removal of more material from the work piece as the saw blade 100 is pulled through the work piece. Hence, the embodiment of band saw blade 100 having teeth with a steeper back angle 145 removes more material per rotation than the conventional blade 10 having back angle 45 of 30-31 degrees.

Performance results reported from sawmill operators indicate tooth 112 of band saw blade 100 makes greater penetration than the tooth 12 of conventional blade 10. Further, because of greater penetration of tooth 112, band saw blade 100 operates more efficiently and stays sharp longer than conventional blade 10. Increases in cutting efficiency can enable a sawmill operator to increase cutting speed and/or extend the blade's useful life.

Note that an improvement in efficiency was determined by observing that the motor rotating blade 110 used less energy than the motor rotating conventional blade 10 for approximately equal amounts of cutting. The decrease in energy use provides a benefit of reducing the energy cost for operating a band saw. Since the teeth 112 of blade 100 make deeper penetration than the teeth 12 of the conventional blade 10, the wood chips (sawdust) produced by blade 100 are larger than the wood chips produced by conventional blade 10. In view of the fact that it is easier for the gullet 15 to remove coarse sawdust, the production of larger wood chips is desirable.

In one sawmill operation using an embodiment of band saw blade 100 for wood cutting operations, where the back angle 145 is about 36 degrees, the time between blade changes increased from about 8 hours for conventional blade 10 to about 17 hours for blade 100. Because an increase in time between blade changes means less operational downtime, blade 100 provides an operation that is significantly more productive than an operation using conventional blade 10. Further, during the sawing operation using blade 100 with a back angle 145 of 36 degrees, the amount of required power decreased when compared with the sawing operation using conventional blade 10.

In other wood cutting experiments, the inventors have determined that a back angle 145 of about 32-33 degrees provides some performance improvement when compared to conventional blade 10. In general, improvement in performance increases as the value of the back angle 145 increases. However, depending on various other parameters, such as blade material and blade thickness, as well as the hardness of the material being cut, a condition may be reached when increasing back angle 145 beyond some threshold value causes an unacceptable level of tooth fracture.

Moreover, an optimal value of back angle 145 may be experimentally determined by using saws with different back angles 145 and observing results and, in particular, observing which saws experienced an unacceptable rate of tooth fracture. The highest back angle 145 that provides an acceptable rate of tooth fracture for the intended material to be cut may then be selected. In this regard, the type of material to be cut is related to the optimal back angle 145. In particular, softer materials generally allow for greater back angles 145. Experiments have shown that, for wood cutting operations, increased back angles between about 32-33 degrees and 46 degrees can provide significant improved performance with very little, if any, increase in incidence of tooth fracture assuming that other design parameters (e.g., blade material, blade thickness, etc.) remain the same. In additional experiments, blades made of the same material (e.g., 1074 or 1075 carbon steel) and having the same thickness (e.g. between approximately 35 thousandths of an inch and 55 thousandths of an inch) were compared. Blades 100 with greater back angles 145 than back angles 45 of conventional blades 10 performed dramatically better in wood cutting operations.

In addition, increasing the back angle 145 generally increases the sharpness of a tooth assuming the hook angle remains unchanged. Moreover, if the back angle 145 is increased, then the hook angle 146 can be decreased without decreasing the sharpness of the tooth relative to the sharpness of a blade without an increased back angle 145. Thus, increasing of the back angle 145 allows the hook angle 146 to be decreased to a greater extent while still achieving a desired sharpness for a tooth. Further, decreasing the hook angle 146 may increase the rate at which wood chips are removed from the cutting area. Moreover, an increased back angle may allow for smaller hook angles resulting in an overall more efficient cutting operation. In one experiment, where back angle 145 was about 46 degrees and hook angle 146 was about 6 degrees, there was a notable increase in cutting performance relative to conventional blade 10. It is contemplated that hook angles 146 could vary between about −5 and 15 degrees, although hook angles outside of this range are also possible. Although 10 degrees is a typical value for hook angle 46 of conventional blade 10, it is believed that using a hook angle 146 less than 10 degrees when the back angle 145 is increased above 32 degrees would yield more optimal results.

FIG. 4 illustrates an embodiment of the disclosure wherein back angle 145 is about 55 degrees and hook angle 146 is about 10 degrees. Each tooth 112 of the embodiment of FIG. 4 has a tooth angle 147 of about 25 degrees (conventional blade 10 has a tooth angle 47 of approximately 49 degrees). Each tooth 112, as illustrated in FIG. 4, is shaped for greater tooth penetration and operates more efficiently than conventional blade 10. Although analysis indicates that the tip strength may be slightly reduced, band saw blade 100 of FIG. 4 is a significant improvement over conventional blade 10 when considering efficiency and downtime.

Results of experiments from several sawmills have provided unexpected performance improvements for wood cutting operations. Embodiments of band saw blade 100, as illustrated for in FIG. 3 and FIG. 4, have shown that band saw blade 100 stays sharp longer and operates significantly more efficient than conventional blade 10. Further, conventional views suggest a significant increase in tooth fractures if back angle 145 exceeds about 30-31 degrees. In contrast to the conventional views, no significant increase in tooth fractures was observed.

Additional operational tests have been conducted at several sawmills when back angle 145 was about 36 degrees for wood cutting operations. The tests demonstrated that blades 100 with a back angle 145 of about 36 degrees were much more efficient than conventional blade 10. Further, blade 100 performed at a desired cutting level between about 50% and 400% longer than conventional blade 10. Not only was blade 100 sharper at the beginning of the tests due to the increased back angle, but blade 100 stayed sharp longer than conventional blade 10. The tests demonstrated there were savings in energy and a reduction in downtime for band saws using blade 100. The reduction in saw downtime provided the desirable benefit of producing more board feet over given period of time.

In summary, observations from various tests on blade 100 with back angles 145 of about 36 degrees or more, when used for cutting wood, are as follows:

Teeth 112 with a back angle 145 of about 36 degrees penetrate wood at least about 50% easier than teeth 12 of conventional blades 10;

When the back angle 145 is greater than about 36 degrees, tooth penetration further improves (increases);

A blade having teeth with a 36 degree back angle remains sharper up to approximately four times longer than teeth of a conventional blade;

The amount of energy required to saw a work piece is decreased thereby reducing energy cost; and

The expected significant increase in tooth fracture with the increased value in back angle did not occur.

The inventors believe that the limit on the value of the back angle 145 is related to the hardness of the wood being cut. For cutting soft wood, such as southern pine, back angle 145 can be greater as compared to back angle 145 for a hard wood, such as for example a dense maple or oak. In disclosed embodiments, the hook angle 146 is between approximately 3 and 12 degrees although other values are possible.

Various benefits of disclosed embodiments of blade 100 indicate that it is desirable to modify blades in accordance with the above descriptions. The benefits of the disclosure may be combined with other blade improvements, such as for example, use of new blade materials, changes in kerf cutting techniques, and sharpening the sides of a tooth. When combining embodiments of the disclosure with other blade improvements, there is a cost reduction benefit for band saw operation at sawmills and other facilities. However, it may be desirable to limit the use of the band saw blade 100 to certain materials depending on various parameters, such as the back angle 145 used and the properties of material being cut. For example, a particular band saw blade 100 may be used for wood cutting operations, but it may be desirable to prevent its use to cut various metals, such as steel, in order to prevent damage to the blade 100. Although the use of the blade 100 may be somewhat more limited by increasing the back angle 145 since it may not be desirable to use the blade 100 to cut at least some materials that otherwise could be cut by the blade 100, such limitations on use may be more than offset by the gains in efficiency for cutting materials that do not cause an unacceptable rate of tooth fracture. Indeed, some sawmill operators, particularly operators that primarily cut relatively soft material, may not view such limitations on use as a significant cost.

The disclosed embodiments may be incorporated during blade manufacturing. In addition, embodiments of the disclosure may be incorporated in conventional blade 10 when blade 10 is sharpened or reworked. When conventional blade 10 is reworked to provide a blade 100 in accordance with the disclosure, the backside 20 of blade 10 may not have the appearance as shown in FIG. 3 and FIG. 4. Experimental results have demonstrated that desirable features of the disclosure include blades that have been reworked.

There are a variety of methods to manufacture a band saw blade. Included in the manufacturing methods are special numerical controlled machines, cam driven machines and machines with adjustable pneumatic arms. Such manufacturing machines process blades in a sequence of metal cutting and/or grinding and positioning techniques.

In general a length of band saw stock material, such as 1074 or 1075 steel, is placed in a manufacturing machine and material is removed until a desired shape, such as producing blade 100 with back angle 145 of greater than 31 degrees, is obtained. For reworking conventional blades 10, a grind rock 200 or other sharpening apparatus may be used to provide back angle 145 for band saw blade 100.

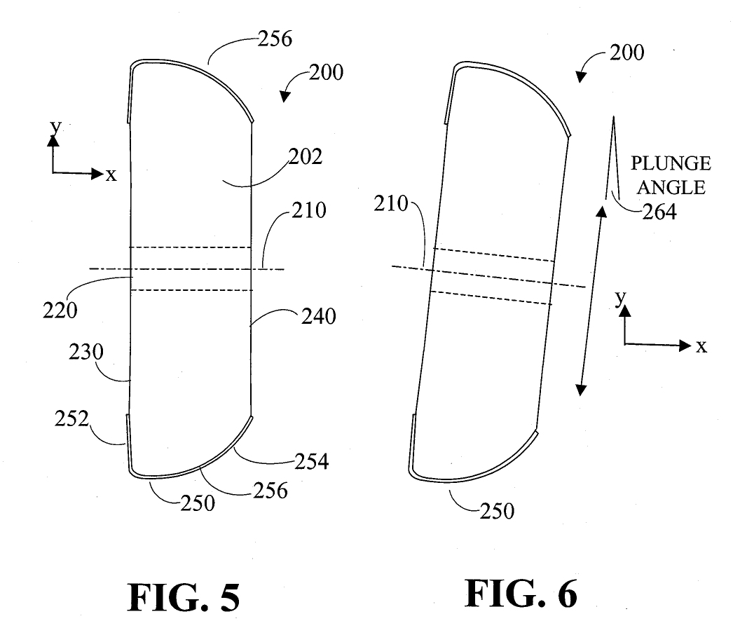

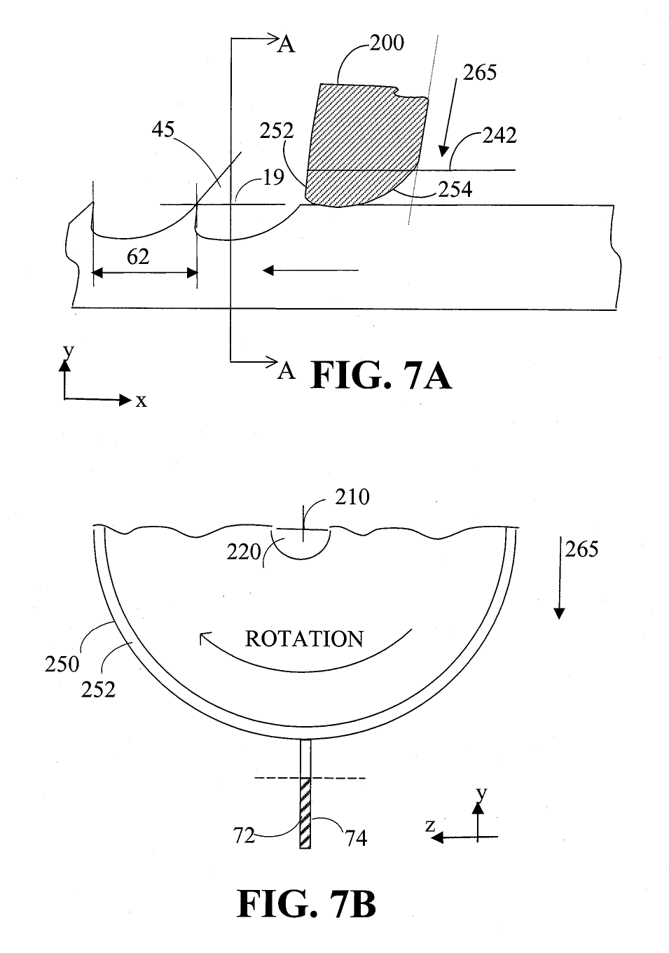

An embodiment of a grind rock 200 of the present disclosure is illustrated in FIG. 5. Grind rock 200 for making embodiments of the present disclosure has a shape that produces a back angle 145 greater than 31 degrees. In general, grind rock 200 functions as a cutting element and may be used, for example, in a profile grinder. Grind rock 200, in one embodiment, has a machined steel body 202 as seen in FIG. 5. Steel body 202 is symmetric about centerline 210 and has a mounting hole 220 aligned with centerline 210. Grind rock 200 has a front surface 230, a back surface 240, and a cutting surface 250 extending between front surface 230 and back surface 240. Cutting surface 250 is comprised of a coating that is deposited on a portion of steel body 202. The coating, a grinding compound or grinding material, in one embodiment is a compound called Borazon (CBN). The CBN is electroplated on selected areas of the surface of steel body 202 as shown in FIG. 5. The cutting surface 250 has a face cutting surface 252 for cutting face 22 of band saw blade 100 and a back cutting surface 254 for cutting back surface 20 of blade 100. A grind rock depth cut line 242 is shown in FIG. 7A. The cut line 242 is defined by the extension of the top surface of the blade when the grind rock 200 has reached a maximum cut depth (best seen in FIG. 9). FIG. 6 depicts grind rock 200 of FIG. 5 tilted at around 10 degrees with respect to vertical (the y direction). An angle associated with the tilt is a plunge angle 264.

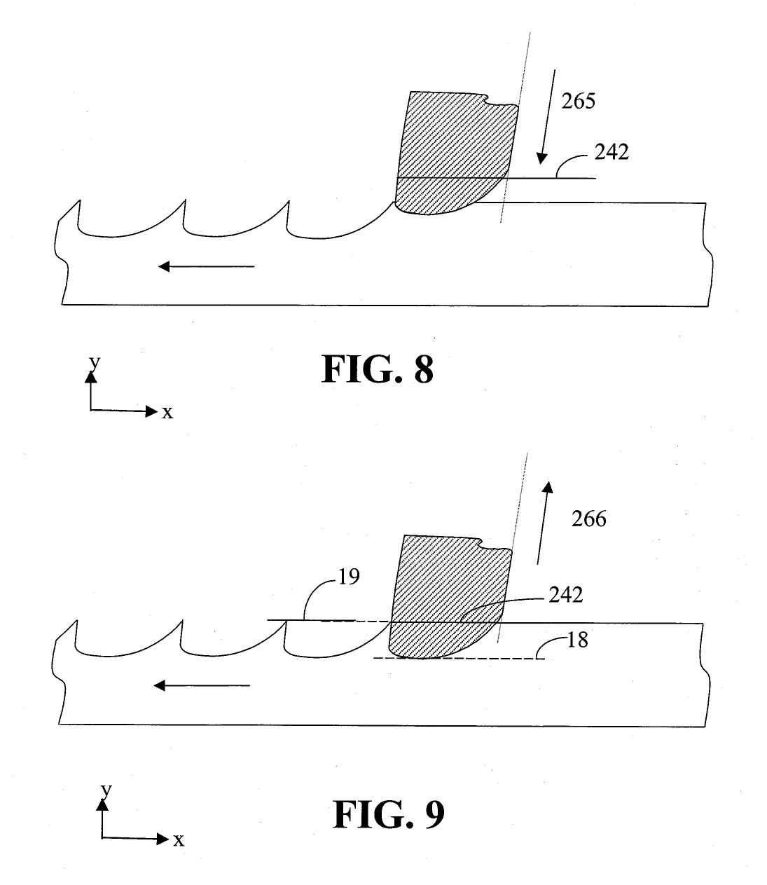

FIG. 7A is a side view of an embodiment of grind rock 200 as grind rock 200 plunges and engages either conventional blade 100 or band saw strip stock (the material used for blade 100) to form each tooth 112 of band saw blade 100. Several teeth have been cut in the blade as can be seen in FIG. 7A. Grind rock 200 is rotating (best seen in FIG. 7B) and is moved towards the saw strip stock in a plunge direction 265. As the grind rock 200 rotates and contacts the blade material, cutting surface 250 of grind rock 200 removes pieces of saw blade material. FIG. 7B illustrates a section view of the grind rock 200 as the grind rock 200 makes contact with saw strip stock. The grind rock 200 is attached to a drive shaft, such as on a plunge grinder, enabling the grind rock 200 to rotate at a desired angular velocity. A reference surface line 242 as shown in FIG. 8 is in congruent with the top edge of the saw strip stock when the grind rock 200 extends into the blade material at a desired maximum depth.

FIG. 8 illustrates grind rock 200 at an intermediate stage of the cutting process. As soon as grind rock 200 extends to a maximum depth, as shown in FIG. 9, grind rock 200 is withdrawn (moved in the negative plunge direction 266) and the blade material moves to the left (the negative x direction). The movement to the left is precise and is referred to as an indexed movement as is understood by those skilled in the art.

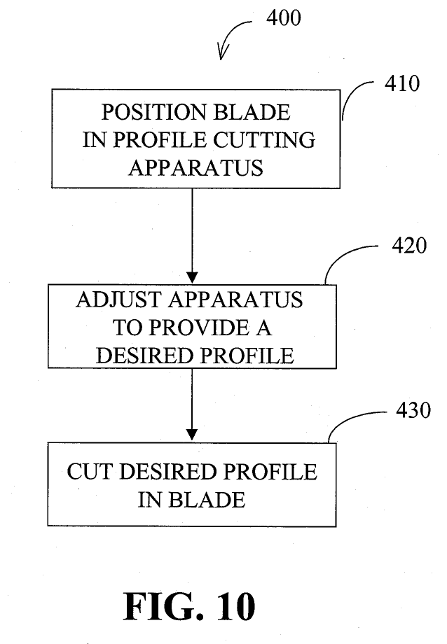

An exemplary method 400 for manufacturing a new blade 100 or reworking a conventional blade 10 is comprised of steps depicted in FIG. 10. A first step 410 is comprised of positioning and securing blade 10 or saw strip stock material within a sharpening apparatus or conventional blade manufacturing apparatus. The next step 420 is comprised of adjusting or programming the manufacturing apparatus to cut a desired shape such as described above and seen in, for example, FIG. 3 or FIG. 4. The next step 430 comprises cutting or modifying a blade or material using the apparatus adjusted or programmed for providing the desired shape. In general, there are a variety of machines that may serve as the apparatus for the method embodiment. Such machines are available from suppliers of blade manufacturing and sharpening equipment. Any machine capable of modifying a blade or manufacturing a blade so that back angle 145 and the face angle 146 have values as disclosed are considered to be within the scope of the present disclosure.

It should be further emphasized that the above-described embodiments of the present disclosure are merely possible examples of implementations, merely set forth for a clear understanding of the principles of the invention. Many variations and modifications may be made to the above-described embodiments of the disclosure without departing substantially from the spirit and principles of the disclosure.

Now, therefore, the following is claimed:

1. A band saw blade comprising a body having a plurality of teeth formed in a surface of the body, at least one tooth of the plurality of teeth having a back angle greater than 33 degrees.

2. The band saw blade of claim 1 wherein each tooth of the plurality of teeth has a hook angle and the hook angle is between zero and 10 degrees.

3. The band saw blade of claim 1 wherein the back angle of at least one tooth of the plurality of teeth is between 35 degrees and 50 degrees.

4. The band saw blade of claim 1 wherein at least one tooth of the plurality of teeth has a tooth angle less than 48 degrees.

5. The band saw blade claim 1 wherein at least one tooth of the plurality of teeth has a tooth angle less than 40 degrees.

6. The band saw blade of claim 1 wherein each tooth of the plurality of teeth has the same tooth angle and a respective back angle greater than 33 degrees.

7. A method of manufacturing a band saw blade, comprising the steps of:
providing a body;
cutting the body thereby forming a plurality of teeth in a surface of the body, wherein the cutting step is performed such that at least one tooth of the plurality of teeth has a back angle greater than 33 degrees.

8. The method claim 7 wherein the cutting step is performed such that a hook angle of the at least one tooth is between zero and 15 degrees.

9. The method of claim 7 wherein the cutting step is performed such that a tooth angle of the at least one tooth is less than 49 degrees.

10. The method of claim 7 wherein the cutting step comprises grinding a grind rock against the surface of the body, and wherein the grind rock is shaped such that the grinding step forms the back angle that is greater than 33 degrees.

11. A method for cutting wood, comprising the steps of:
rotating a band saw blade having a plurality of teeth, at least one tooth of the plurality of teeth having a back angle greater than 33 degrees; and
moving a piece of wood toward the rotating band saw blade such that the piece is cut by the band saw blade.

12. A band saw blade comprising a body having a plurality of teeth formed in a surface of the body, wherein the body forms a loop, and wherein at least one tooth of the plurality of teeth has a back angle greater than 33 degrees and a hook angle less than 15 degrees.

13. The blade of claim 12 wherein the at least one tooth has a tooth angle less than 49 degrees.

14. The blade of claim 13 wherein the at least one tooth has a negative hook angle.

15. The blade of claim 12 wherein the at least one tooth has a back angle between 35 degrees and 60 degrees.

16. The blade of claim 12 wherein each tooth of the plurality of teeth has a back angle greater than 33 degrees.

17. The blade of claim 12 wherein the teeth are spaced at equal distances.

18. The blade of claim 12 wherein each tooth of the plurality of teeth has the same back angle and the same hook angle.

19. The blade of claim 12 wherein the back angle is greater than 40 degrees.

20. The blade of claim 19 wherein the hook angle is less than 5 degrees.
